(19) United States
(12) Patent Application Publication
(10) Pub. No.: US 2018/0196295 A1
(43) Pub. Date: Jul. 12, 2018

(54) Array Substrate and LCD

(71) Applicant: Wuhan China Star Optoelectronics Technology Co. Ltd., Wuhan-Hubei (CN)

(72) Inventors: Zhenzhou XING, Shenzhen, Guangdong (CN); Xingling GUO, Shenzhen, Guangdong (CN); Man LI, Shenzhen, Guangdong (CN)

(73) Assignee: Wuhan China Star Optoelectronics Technology Co. Ltd., Wuhan, Hubei (CN)

(21) Appl. No.: 15/123,675

(22) PCT Filed: Jul. 21, 2016
(86) PCT No.: PCT/CN2016/090787

§ 371 Date: Sep. 5, 2016

(30) Foreign Application Priority Data
Jun. 22, 2016 (CN) 201610462771.1

(51) Int. Cl. G02F 1/133; G02F 1/1362; G02F 1/1345

(52) U.S. Cl. CPC G02F 1/13306; G02F 1/133514; G02F 1/13452; G02F 1/136286

(57) ABSTRACT

An array substrate includes: a substrate, scan lines, and wires connecting to the scan lines. A gate driver provides scan signals to the scan lines through the wires. The wires extend dispersedly along the direction from the gate driver to the scan lines. The number of amplifiers corresponding to some output channels of the gate driver is different, so that an output drive capability provide to the some output channels of the gate driver is different. The output drive capability of the scan signals provided by the gate driver to the wires is larger if the wires is closer to the edge of the substrate, so that the RC delay are the same when the scan signals pass through the wires. It prevents uneven brightness or color of the displayed images due to different RC delays of scan signals, thus elevates the display quality.

### BACKGROUND

### 1. Field of the Invention

The present disclosure relates to the field of display technology, and more specifically, to an array substrate and liquid crystal display.

### 2. Description of the Related Art

Thin-film transistor-liquid crystal display (TFT-LCD) is an ingenious combination of micro-electricity and LCD technologies. People make use of microelectrical precision processing technology applied to silicon, and employ TFT array processing on large-scale glass. Then, mature LCD technology is applied to the array substrate and another substrate with a color filter to form a liquid crystal cell. Afterwards, procedure such as adhering a polarizer is applied so to form a LCD.

While the display technology is developing rapidly, TFT-LCDs are required to have narrower bezel and higher resolution—people are demanding higher standards and lower costs. As the number of gate drivers become less and the bezel become narrower, it is more difficult to fan out. When a production parameter (such as the thickness of the film) changes or wires on array (WOA) has a poor impedance matching, it causes uneven brightness or color, commonly known as Mura.

### SUMMARY

One object of the present disclosure is to provide an array substrate and LCD which can prevent uneven brightness or color of the displayed images due to different resistive-capacitive (RC) delays of scan signals, thus elevates the display quality.

According to the present disclosure, an array substrate includes: a substrate having a display area and a non-display area, a plurality of scan lines disposed on the display area, and a plurality of wires disposed on the non-display area connecting to the plurality of scan lines. A gate driver provides scan signals to the plurality of scan lines through the plurality of wires. The plurality of wires extend dispersedly along the direction from the gate driver to the scan lines. The number of amplifiers corresponding to some output channels of the gate driver is different, so that an output drive capability provide to the some output channels of the gate driver is different. The output drive capability of the scan signals provided by the gate driver to the wires is larger if the wires is closer to the edge of the substrate, so that the resistive-capacitive (RC) delay are the same when the scan signals pass through the plurality of wires.

Furthermore, the output drive capability of the scan signals provided by the gate driver to the wires is positively related to the impedance of the wires.

Furthermore, the output drive capability of the scan signals provided by the gate driver to the wires is positively related to the distance between the corresponding gate driver and the scan lines.

Furthermore, the output drive capability is an output buffer drive ability of currents outputted by the gate driver, and the output buffer drive ability is negatively related to the time of rising edge or falling edge of the outputted waveform.

Furthermore, the plurality of scan lines are disposed horizontally on the display area. The array substrate further includes a plurality of data lines disposed vertically on the display area. A plurality of scan lines and data lines define a plurality of pixel areas on the display area. The array substrate further includes a plurality of switch elements, disposed respectively on a plurality of pixel areas, with the switch elements connected to the scan lines and data lines.

Furthermore, the plurality of switch elements are thin film transistors.

According to the present disclosure, an array substrate includes: a substrate having a display area and a non-display area, a plurality of scan lines disposed on the display area, and a plurality of wires disposed on the non-display area connecting to the plurality of scan lines. A gate driver provides scan signals with a certain level of output drive capability to the scan lines through the wires, and some of the wires are provided with scan signals of different output drive capability, so that the RC impedance are the same when the scan signals pass through the plurality of wires.

Furthermore, the gate driver provides scan signals to the plurality of scan lines through the plurality of wires. The plurality of wires extend dispersedly along the direction from the gate driver to the scan lines. The output dive capability of the scan signals provided by the gate driver to the wires is larger if the wires is closer to the edge of the substrate.

Furthermore, the output drive capability of the scan signals provided by the gate driver to the wires is positively related to the impedance of the wires.

Furthermore, the output drive capability of the scan signals provided by the gate driver to the wires is positively related to the distance between the corresponding gate driver and the scan lines.

Furthermore, the output drive capability is an output buffer drive ability of currents outputted by the gate driver, and the output buffer drive ability is negatively related to the time of rising edge or falling edge of the outputted waveform.

Furthermore, the number of amplifiers corresponding to some output channels of the gate driver is different, so that the output drive capability provide to the some output channels of the gate driver is different.

Furthermore, the plurality of scan lines are disposed horizontally on the display area. The array substrate further includes a plurality of data lines disposed vertically on the display area. A plurality of scan lines and data lines define a plurality of pixel areas on the display area. The array substrate further includes a plurality of switch elements, disposed respectively on a plurality of pixel areas, with the switch elements connected to the scan lines and data lines.

Furthermore, the plurality of switch elements are thin film transistors.

According to the present disclosure, a liquid crystal display includes a display panel and a backlight module. The display panel includes an array substrate, a color film substrate, and a liquid crystal layer between the array substrate and the color film layer. The array substrate includes: a substrate having a display area and a non-display area, a plurality of scan lines disposed on the display area, and a plurality of wires disposed on the non-display area connecting to the plurality of scan lines. A gate driver provides scan signals with a certain level of output drive capability to the scan lines through the wires, and some of the wires are provided with scan signals of different output drive capability, so that the RC impedance are the same when the scan signals pass through the plurality of wires.

Furthermore, the gate driver provides scan signals to the plurality of scan lines through the plurality of wires. The plurality of wires extend dispersedly along the direction from the gate driver to the scan lines; the output drive capability of the scan signals provided by the gate driver to the wires is larger if the wires is closer to the edge of the substrate.

Furthermore, the output drive capability of the scan signals provided by the gate driver to the wires is positively related to the impedance of the wires.

Furthermore, the output drive capability of the scan signals provided by the gate driver to the wires is positively related to the distance between the corresponding gate driver and the scan lines.

Furthermore, the output drive capability is an output buffer drive ability of currents outputted by the gate driver, and the output buffer drive ability is negatively related to the time of rising edge or falling edge of the outputted waveform.

Furthermore, the number of amplifiers corresponding to some output channels of the gate driver is different, so that the output drive capability provide to the some output channels of the gate driver is different.

Different from related art, the array substrate of the present disclosure includes an array substrate, including display areas and non-display areas; a plurality of scan lines disposed on the display areas; a plurality of WOA disposed on the non-display areas, with the plurality of WOA connected to the plurality of scan lines, and the gate driver providing scan signals to the scan lines through the WOA. The gate driver provides scan signals with a certain level of output drive capability to the plurality of WOA. The scan signals provided to some WOA have different output drive capability, so that the RC delays generated when the scan signals pass through the plurality of WOA are the same. The abovementioned method can adjust the output drive capability of the scan signals provided to WOA, lowers the RC delay of WOA with larger impedance, so that scan lines corresponding to each WOA can be charged at the same time. It prevents uneven brightness or color of the displayed images due to different RC delays of scan signals, thus elevates the display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural diagram of an array substrate according to a preferred embodiment of the present disclosure.

FIG. 2 shows a schematic diagram of a pixel area of the array substrate according to a preferred embodiment of the present disclosure.

FIG. 3 shows an arrangement of wires of the array substrate according to a preferred embodiment of the present disclosure.

FIG. 4 shows a comparison of current drive capability of the array substrate according to a preferred embodiment of the present disclosure.

FIG. 5 shows a schematic diagram of a liquid crystal display according to a preferred embodiment of the present disclosure.

### DETAILED DESCRIPTION OF PREFERRED EMBODIMENTS

Please refer to FIG. 1. FIG. 1 is a structural diagram of an array substrate according to a preferred embodiment of the present disclosure. The array substrate includes a substrate 11, a plurality of scan lines 12, and a plurality of wires 13.

The substrate 11 includes a display area 111 and a non-display area 112.

Preferably, the substrate 11 is made of a transparent glass or plastic.

The plurality of scan lines 12 are disposed on the display area 111. Preferably, The plurality of scan lines 12 are disposed horizontally on the display area 111.

The plurality of wires 13, disposed on the non-display area 112. The plurality of wires 13 is connected to the plurality of scan lines 12 respectively. A gate driver 14 provides scan signals to scan lines 12 through wires 13.

Preferably, the array substrate further includes a plurality of data lines 15, disposed vertically on the display area 111. The plurality of scan lines 12 and data lines 15 define a plurality of pixel areas in the display area 111.

The scan lines 12, wires 13 and data lines 15 are disposed between a variety of films on the substrate 11. These films can be insulating layers, passivation layers, passivation layers, organic layers, inorganic layers, semi-conducting layers, metal layers, and so on.

The number of scan lines 12, wires 13, gate driver 14 and data lines 15 in FIG. 1 are not limited to in the present embodiment.

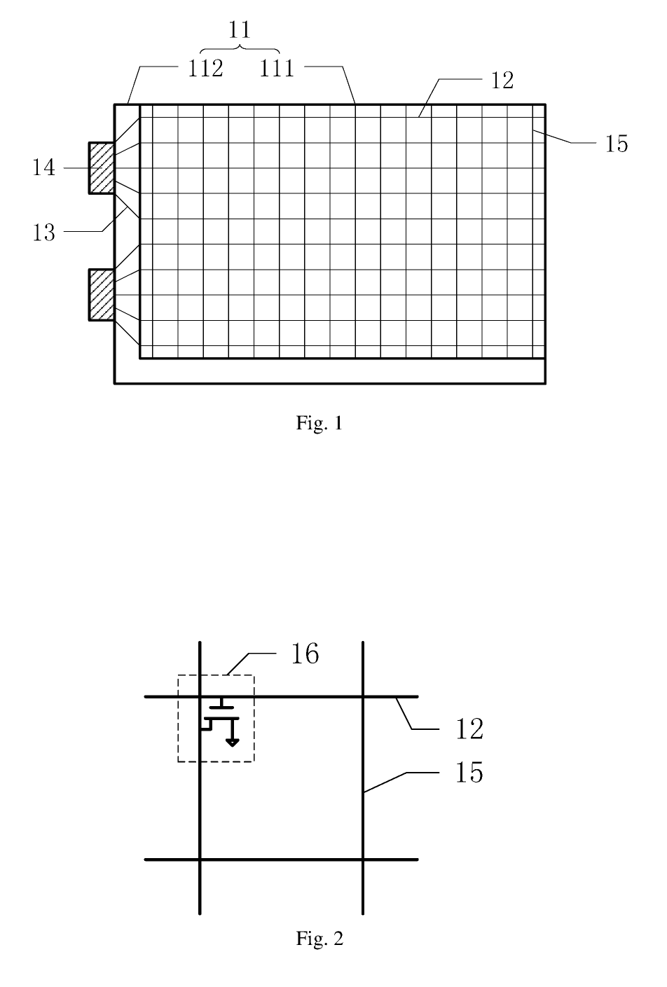

Please refer to FIG. 2. The array substrate further includes a plurality of switch elements 15, disposed in the plurality of pixel areas respectively. Each of the switch elements 15 is connected to one of the scan lines 12 and one of the data lines 15. Specifically, the switch elements 15 are TFTs, whose gates are connected to the scan lines 12, sources are connected to the data lines 15, and drains are connected to pixel electrodes (not shown in FIG. 2).

Because of the development of display technology, requirements for the bezel of LCDs are becoming stricter. Currently, LCDs are commonly required to be of narrow bezel, therefore the number and size of gate drivers 14 must be reduced. So one gate driver 14 must correspondingly provide scan signals to more scan lines 12.

With the current technology, the wires 13 that connects the gate drivers 14 and scan lines 12 has a fan-out structure, meaning that the input ends of the wires 13 closely align together, whereas the output ends spread out. However, the horizontal distance between the gate driver 14 and scan lines 12 are fixed, so that the length of some wires 13 is varied. In other words, the wires 13 close to the edge of the substrate is longer than the wires 13 close to the middle.

The abovementioned arrangement leads to different impedances of different wires 13, further causing different RC delays of different wires 13 when scan signals pass through. It gives rise to uneven brightness or color, commonly known as Mura

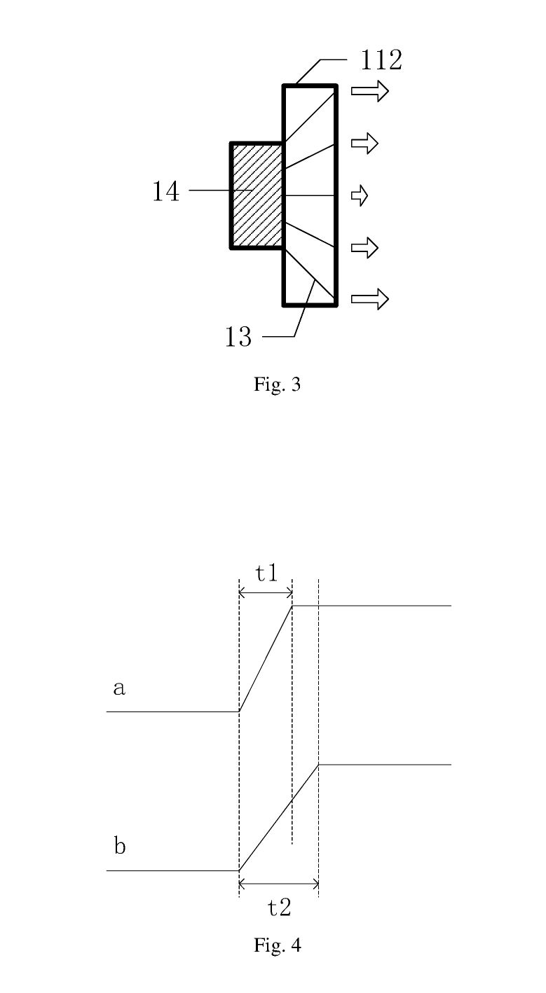

Please refer to FIG. 3. The hollowed arrows stand for output current drive capability. The larger the arrow, the larger the output drive capability.

Specifically, the gate driver 14 provides scan signals with a certain level of output current drive capability to a plurality of wires 13. The output current drive capability of scan signals provided to some wires 13 is different, so that the RC delays of a plurality of wires 13 is the same when the scan signals pass through.

As used herein, the output drive capability means that drive capability of current from output buffers of the gate driver. The drive capability of current from the output buffer is negatively related to the time of rising edge or falling edge of the output waveform.

Please refer to FIG. 4 for more specific details. Signals a and b are clock scan signals. The time that signal a rises from a low level to a high level (i.e. the rising edge) is t1. The time that signal b rises from a low level to a high level is t2. If t1 is shorter than t2, it means that he drive capability of current from the output buffer of signal a is better than that of signal b.

Please refer to both FIG. 3 and FIG. 4. The length of the wires 13 may be different, meaning that the impedance of wires 13 may be different. However, through enhancing the output drive capability of an input signal of wires 13 with larger impedance, the wires 13 with larger impedance gets inversive compensation. Therefore, the scan lines corresponding to wires 13 with larger impedance can also rise rapidly to a high level when being charged, and reduce the RC delay.

Preferably, the gate driver 14 provides scan signals to a plurality of scan lines 12 respectively through a plurality of wires 13. The plurality of wires 13 is dispersed along the direction from the gate driver 14 to the scan lines 12. Among the plurality of wires 13, the output drive capability of the scan signal provided by gate driver 14 to the wires 13 is larger if the wires 13 is closer to the edge of the substrate.

As shown in FIG. 3, the gate driver 14 provides scan signals with larger output drive capability to longer wires 13, and scan signals with smaller output drive capability to shorter wires 13.

The output drive capability of the scan signals provided to the wires 13 by the gate driver 14 is positively related to the impedance of the wires 13.

The output drive capability of the scan signals provided to the wires 13 by the gate driver 14 is positively related to the distance between the corresponding gate driver 14 and scan lines 12.

Specifically, the output drive capability in different channels of the gate driver 14 can be adjusted by changing the number of amplifiers or the multiple by which the amplifiers amplify the thrust in different channels of the gate driver 14. For example, the number of amplifiers corresponding to some output channels of the gate driver 14 are different, so that the output drive capability provided by the gate driver to those output channels are different.

the array substrate of the present disclosure includes an array substrate, including display areas and non-display areas; a plurality of scan lines disposed on the display areas; a plurality of wires disposed on the non-display areas, with the plurality of wires connected to the plurality of scan lines, and the gate driver providing scan signals to the scan lines through the wires. The gate driver provides scan signals with a certain level of output drive capability to the plurality of wires. The scan signals provided to some wires have different output drive capability, so that the RC delays generated when the scan signals pass through the plurality of wires are the same. The method can adjust the output drive capability of the scan signals provided to wires, lowers the RC delay of wires with larger impedance, so that scan lines corresponding to each wires can be charged at the same time. It prevents uneven brightness or color of the displayed images due to different RC delays of scan signals, thus elevates the display quality.

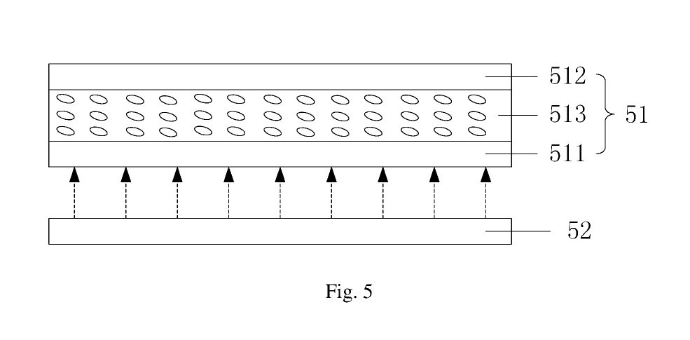

Please refer to FIG. 5. FIG. 5 is a structural diagram of the LCD according to a preferred embodiment of the present disclosure. The LCD includes a display panel 51 and a backlight module 52. The display panel 51 includes an array substrate 511, a color film substrate 512 and a liquid crystal layer 513 between the array substrate 511 and color film substrate 512.

The array substrate 511 includes a substrate having a display area and a non-display area, a plurality of scan lines disposed on the display area, a plurality of wires disposed on the non-display area. The plurality of wires connect to the plurality of scan lines. A gate driver provides scan signals to the scan lines through the wires. The gate driver provides scan signals with a certain level of output drive capability to the plurality of wires, and some of the wires are provided with scan signals of different output drive capability, so that the resistance-capacitance (RC) delay are the same when the scan signals pass through the plurality of wires.

Specifically, the array substrate 511 is an array substrate that is in line with the substrates in the abovementioned embodiments. The structure and the operation principles are similar to those in the abovementioned embodiments. Please refer to the explanation and figures of the abovementioned embodiments. No further explanation is provided here.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An array substrate, comprising:
a substrate, comprising a display area and a non-display area;
a plurality of scan lines, disposed on the display area;
a plurality of wires, disposed on the non-display area, connecting to the plurality of scan lines, wherein a gate driver provides scan signals to the plurality of scan lines through the plurality of wires;
wherein the plurality of wires extend dispersedly along the direction from the gate driver to the scan lines; the number of amplifiers corresponding to some output channels of the gate driver is different, so that an output drive capability provide to the some output channels of the gate driver is different; the output drive capability of the scan signals provided by the gate driver to the wires is larger if the wires is closer to the edge of the substrate, so that the resistive-capacitive (RC) delay are the same when the scan signals pass through the plurality of wires.

2. The array substrate of claim 1, wherein the output drive capability of the scan signals provided by the gate driver to the wires is positively related to the impedance of the wires.

3. The array substrate of claim 1, wherein the output drive capability of the scan signals provided by the gate driver to the wires is positively related to the distance between the corresponding gate driver and the scan lines.

4. The array substrate of claim 1, wherein the output drive capability is an output buffer drive ability of currents outputted by the gate driver, and the output buffer drive ability is negatively related to the time of rising edge or falling edge of the outputted waveform.

5. The array substrate of claim 1, wherein the plurality of scan lines are disposed horizontally on the display area;
the array substrate further comprises a plurality of data lines disposed vertically on the display area; a plurality of scan lines and data lines define a plurality of pixel areas on the display area;
the array substrate further comprises a plurality of switch elements, disposed respectively on a plurality of pixel areas, with the switch elements connected to the scan lines and data lines.

6. The array substrate of claim 5, wherein the plurality of switch elements are thin film transistors.

7. An array substrate, comprising:
a substrate, comprising a display area and a non-display area;
a plurality of scan lines, disposed on the display area;
a plurality of wires, disposed on the non-display area, connecting to the plurality of scan lines,
wherein a gate driver provides scan signals with a certain level of output drive capability to the scan lines through the wires, and some of the wires are provided with scan signals of different output drive capability, so that the resistive-capacitive (RC) impedance are the same when the scan signals pass through the plurality of wires.

8. The array substrate of claim 7, wherein the gate driver provides scan signals to the plurality of scan lines through the plurality of wires;
wherein the plurality of wires extend dispersedly along the direction from the gate driver to the scan lines; the output drive capability of the scan signals provided by the gate driver to the wires is larger if the wires is closer to the edge of the substrate.

9. The array substrate of claim 8, wherein the output drive capability of the scan signals provided by the gate driver to the wires is positively related to the impedance of the wires.

10. The array substrate of claim 8, wherein the output drive capability of the scan signals provided by the gate driver to the wires is positively related to the distance between the corresponding gate driver and the scan lines.

11. The array substrate of claim 7, wherein the output drive capability is an output buffer drive ability of currents outputted by the gate driver, and the output buffer drive ability is negatively related to the time of rising edge or falling edge of the outputted waveform.

12. The array substrate of claim 7, wherein the number of amplifiers corresponding to some output channels of the gate driver is different, so that the output drive capability provide to the some output channels of the gate driver is different.

13. The array substrate of claim 7, wherein the plurality of scan lines are disposed horizontally on the display area;
the array substrate further comprises a plurality of data lines disposed vertically on the display area; a plurality of scan lines and data lines define a plurality of pixel areas on the display area;
the array substrate further comprises a plurality of switch elements, disposed respectively on a plurality of pixel areas, with the switch elements connected to the scan lines and data lines.

14. The array substrate of claim 13, wherein the plurality of switch elements are thin film transistors.

15. A liquid crystal display comprising a display panel and a backlight module, the display panel comprising an array substrate, a color film substrate, and a liquid crystal layer between the array substrate and the color film layer, wherein the array substrate comprises:
a substrate, comprising a display area and a non-display area;
a plurality of scan lines, disposed on the display area;
a plurality of wires, disposed on the non-display area, connecting to the plurality of scan lines,
wherein a gate driver provides scan signals with a certain level of output drive capability to the scan lines through the wires, and some of the wires are provided with scan signals of different output drive capability, so that the resistive-capacitive (RC) delay are the same when the scan signals pass through the plurality of wires.

16. The liquid crystal display of claim 15, wherein the gate driver provides scan signals to the plurality of scan lines through the plurality of wires;
wherein the plurality of wires extend dispersedly along the direction from the gate driver to the scan lines; the output drive capability of the scan signals provided by the gate driver to the wires is larger if the wires is closer to the edge of the substrate.

17. The liquid crystal display of claim 16, wherein the output drive capability of the scan signals provided by the gate driver to the wires is positively related to the impedance of the wires.

18. The liquid crystal display of claim 16, wherein the output drive capability of the scan signals provided by the gate driver to the wires is positively related to the distance between the corresponding gate driver and the scan lines.

19. The liquid crystal display of claim 15, wherein the output drive capability is an output buffer drive ability of currents outputted by the gate driver, and the output buffer drive ability is negatively related to the time of rising edge or falling edge of the outputted waveform.

20. The liquid crystal display of claim 15, wherein the number of amplifiers corresponding to some output channels of the gate driver is different, so that the output drive capability provide to the some output channels of the gate driver is different.
